(19) United States
(12) Patent Application Publication
(10) Pub. No.: US 2026/0038063 A1
(43) Pub. Date: Feb. 5, 2026

(54) MULTI-PURPOSE QR CODE / RFID TAG WORKFLOW

(71) Applicant: Hospitality Pulse, LLC, Cleveland, OH (US)

(72) Inventors: Ryan Overman, Dayton, OH (US); Christina Michalenko, Beaver, PA (US); Jesse Weiland, Murrysville, PA (US); Jim Overman, Akron, OH (US)

(21) Appl. No.: 19/284,767

(22) Filed: Jul. 30, 2025

Related U.S. Application Data
(60) Provisional application No. 63/677,476, filed on Jul. 31, 2024.

(51) Int. Cl. G06Q 50/12; G06K 19/06; G06K 19/07; G06Q 10/0631

(52) U.S. Cl. CPC G06Q 50/12; G06K 19/06037; G06K 19/0723; G06Q 10/0631

(57) ABSTRACT

Techniques, described herein, enable a system of an enterprise to provide one or more of: Quick Response (QR) codes or radio frequency identification (RFID) tags corresponding to a plurality of locations for a plurality of user equipment devices (UE). Each location can be affiliated to a QR code or an RFID tag. Sets of tasks can be associated with status levels at the location that can be provided to the UEs in response to an authentication with the QR code or RFID tag within a proximity area of the location. Each of the sets of tasks can vary with each of the status levels.

### CROSS REFERENCE TO RELATED APPLICATION

The present application claims priority to U.S. Patent Application No. 63/677,476, filed Jul. 31, 2024, entitled MULTI-PURPOSE QR CODE/RFID TAG WORKFLOW, the disclosure of which is incorporated herein by reference in its entirety.

### FIELD

This disclosure relates to computerized networks and data management systems for managing workflows by a multi-purpose Quick Response (QR) code/Radio Frequency Identification (RFID) tag particularly in the hospitality field.

### BACKGROUND

Computerized networks and data management systems can include a variety of systems, devices, and technologies to enable users to create, store, access, and distribute information. Such networks can include one or more wired networks, wireless networks, or a combination thereof. Each network can include a broad range of interconnected devices, each comprising hardware, software, virtualization technology, etc., which enables the devices to send, receive, process, and/or store information. Examples of such devices can include mobile user devices (e.g., cell phones, tablet computers, laptop computers, etc.) stationary devices (e.g., desktop computer, servers, etc.), and network components and devices (e.g., network hubs, routers, base stations, satellite systems, etc.).

Extended stay lodges (hotels, apartments, resorts, condos, etc.) generally offer long term accommodation for guests or clients that include various amenities or services such as self-serve laundry, in-suite kitchens, on-demand maid or room service, and other similar amenities or services. An extended stay lodges lodge guests generally longer than one or two nights on average, where the majority of guests (or clients) stay for five to seven days at a minimum, but overnight bookings or stays can range from months to years as well. Because extended stay lodges differ in workflow from overnight hotels, where one or two nights is the duration of a stay on average, the workflow of an extended stay lodge can be more involved. Therefore, a demand exists for having efficient workflow management applications.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., can not necessarily refer to the same aspect, implementation, etc., and can mean at least one, one or more, etc.

FIG. 1 is a diagram of an example overview according to one or more implementations (aspects) described herein.

FIG. 2 is a diagram of an example system according to one or more implementations described herein.

FIG. 3 is a diagram of an example of functionalities of a workflow application platform according to one or more implementations described herein.

FIG. 4 is an example process flow for a workflow application according to one or more implementations described herein

FIG. 5 is a diagram of an example user interface for creating a workflow application account according to one or more implementations described herein.

FIG. 6 is a diagram of another example user interface for creating a workflow application account as a guest user according to one or more implementations described herein.

FIG. 7 is a diagram of another example user interface for a checklist and requests progress for a workflow application according to one or more implementations described herein.

FIG. 8 is a diagram of another example user interface for a workflow application according to one or more implementations described herein.

FIG. 9 is a diagram of another example user interface with a user profile for a workflow application according to one or more implementations described herein.

FIG. 10 is a diagram of another example user interface with set of tasks according to a user status level or role for a workflow application according to one or more implementations described herein.

FIG. 11 is a diagram of another example user interface with set of tasks and additional information according to a user status level or role for a workflow application according to one or more implementations described herein.

FIG. 12 is a diagram of another example user interface with set of tasks and additional information according to a user status level or role for a workflow application according to one or more implementations described herein.

FIG. 13 is a diagram of another example user interface for various user requests for a workflow application according to one or more implementations described herein.

FIG. 14 is a diagram of another example user interface for additional resources for a workflow application according to one or more implementations described herein.

FIG. 15 is a diagram of another example user interface for a workflow application according to one or more implementations described herein.

FIG. 16 is a diagram of another example user interface for a workflow application according to one or more implementations described herein.

FIG. 17 illustrates another example of a process flow for a workflow application in accordance with various aspects described herein;

FIG. 18 illustrates another example of a process flow for a workflow application in accordance with various aspects described herein;

FIG. 19 illustrates another example of a process flow for an administration workflow application in accordance with various aspects described herein;

FIG. 20 illustrates another example of a process flow for a workflow application in accordance with various aspects described herein;

FIG. 21 illustrates another example of a process flow for a workflow application in accordance with various aspects described herein; and

FIG. 22 is a block diagram representing exemplary non-limiting networked environments in which various non-limiting aspects described herein can be implemented.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

As utilized in this disclosure, terms “component,” “system,” “interface,” and the like are intended to refer to a computer-related entity, hardware, software (e.g., in execution), and/or firmware. For example, a component can be a processor (e.g., a microprocessor, a controller, or other processing circuitry or device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. The term “circuitry” may refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some aspects, circuitry may include logic, at least partially operable in hardware.

Workflow operations within an enterprise or entity demand an efficient operations process that involves multiple individuals working throughout the industry (e.g., the hospitality industry, restaurant industry or other industry), each with a different responsibility to the workspace. For example, when a guest checks out of a guest lodging (e.g., a cabin, chalet, extended stay resort, room, or other over-night accommodation), someone assigned to do preparation (prep) of the room for the day can go to the lodging and strip out the dirty linen, collect the trash, or sweep the floors to prepare the location for another worker such as a housekeeper. The person assigned to prepping (e.g., a prepper) could also leave behind clean linen, provide other inventory, or perform other tasks that may be a precursor to the next user employee to perform additional tasks. A housekeeper can then come to the lodging to clean the room(s), make the bed, or perform other more granular services than the prepper. Finally, a manager on duty can inspect the lodging or room before making it available for the next guest stay at or be served, for example.

Systems, devices or applications herein can operate to enable a hierarchy of status levels with various tasks or responsibilities at each status level of the hierarchy to be completed before the next status level is activated for another individual with assigned responsibilities to undertake at the same location. For example, a set of three or more roles (or status levels) can be assigned for the lodging at each location, each with different responsibilities assigned to the location, and all working to support each other, and reliant upon completion of tasks from a staff user or member at one status level. When tasks associated with a status level are completed and the station or location is ready for tasks from a user or staff member of a different status level of tasks, a completion indication (e.g., message, text, graphic or other indication) may be provided to the assigned user of the next or different status level with different tasks than the first user with tasks of a first status level.

In an aspect, the system, device, or application can enable an efficient way to train, maintain, and monitor performance for each of various roles (or status levels) without a large footprint, which can be customized both to the role and to the specific user or user equipment (UE) device of the user through Quick Response (QR) code, a radio frequency identification (RFID) tag or both for various locations. Each employee who interacts with a location as a user can be provided a custom list of tasks to be completed after authenticating or scanning the QR code or RFID tag at each particular location. Each worker or employee can further provide checked off tasks that are completed, an escalation of issues that are encountered for another status level or other employee with a different role to be assigned as additional tasks, and receive real time updates on progress as tasks are in progress or completed for the location based on the QR code or RFID tag at the location of the lodging.

As an employee, guest or user of a UE authenticates into the system in response to scanning the QR code or RFID tag of a location, various user experiences can be provided depending on the status level or role of the user. For example, a guest can enable a ticket request for a tailored need or maintenance issue, while different employee roles or status levels can be assigned different tasks associated with the location via the same QR code or RFID tag.

A property or entity as referred to herein can be geographical area, a physical building or structure with a physical mailing address, for example. An entity can also be a business or enterprise, such as a hospitality enterprise. A location can be referred to as a defined unique space or object within a property or entity such as a lodging destination, a room, a lobby, a fitness center, or particular object to be maintained such as a fire extinguisher, or other location. A location that includes a lodging destination or a room, for example, can further include various stations such as a kitchen, bed(s), living room, and other amenities that accompany extended stay or overnight room stays. Each of these stations, compartments or areas of the location can be assigned different tasks among different sets of tasks assigned to the status level of the location and of the user. The tasks referred to herein can be a collection of work related responsibilities associated with an individual's role or status level and the location status on the property or entity. The tasks correspond to an activity to be performed and the location they are being performed at in association with a unique location code (e.g., a QR code or RFID tag) assigned to the location.

In addition, a role can be the current level of responsibility or a user status assigned to an employee working within the location through the application via the QR code or RFID tag, including, but not limited to, a preparation attendant (prepper), housekeeping attendant (housekeeper), public space attendant (administrator or host), a General Manager, a maintenance technician, an inspection manager or other level of assigned responsibility. A status level can be indicative of the status of the location as a location status level assigned with the particular and unique QR code or RFID tag for the user/user device assigned a particular user role or user status level to address with a set of tasks by performing those assigned tasks. A user device associated with a user can fulfill multiple roles or have different user status levels over the course of the day when assigned via the QR code or RFID tag. The user device can also have tasks modified and updated depending on the status level of the location, the location itself, entity/property that the location is at, a season or a time of year, or an ad hoc event occurring or being scheduled, for example.

In an aspect, a system of an enterprise network (e.g., local Wi-Fi network, intranet, or the like) or enterprise entity, business or organization can operate to generate a location code at a location for one or more user equipment (UEs) or user devices. The location code can be a QR code or an RFID tag that is physically at the location and is distinguished or unique from the QR code or RFID tag at other locations within the same entity or business. Each entity or business can have multiple locations (e.g., lodgings, rooms, or the other amenity or accommodation) with a QR code or RFID tag, respectively. In response, to a user with a user device identifying the QR code or RFID tag, the user device can be provided a set of tasks depending on the user ID, the status level of the room or an authentication level of the device after scanning the QR code or RFID tag at the location. Each location can have a different status level, with a different role activated, and different tasks for each status level or activated role to be performed by a worker, employee or user. Additional aspects, embodiments or details of the disclosure are further described below with reference to figures.

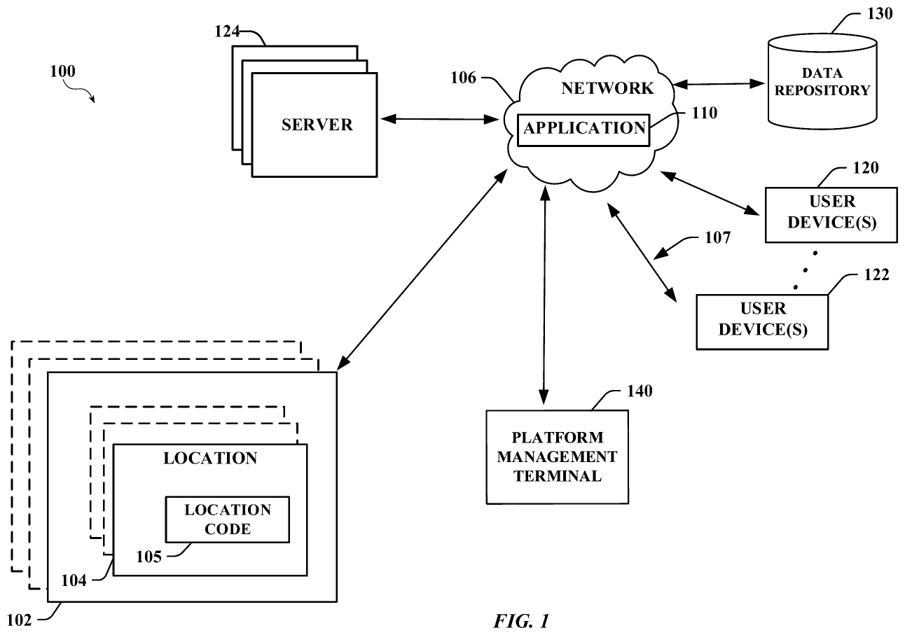

Referring to FIG. 1, illustrated is an example environment or system 100 for implementing a workflow application within various entities of an enterprise. The system 100 includes one or more entities 102 that can be at various destinations or geographical boundaries (e.g., cities, states, nations, or other geographical/political boundaries). Each entity 102 includes different locations 104 and each location includes an assigned location code 105 including a QR code or an RFID tag for authenticating one or more user devices 120 or 122 with the network 106, server 124 of the network, or application 110 communicatively coupled with the user devices 120 or 122.

The location code 105 at each location 104 can be detected or identified within a proximate area by a user device 120 or 122. A user device can include a user equipment (UE) such as a smart phone, mobile device, internet of things (IoT) device or other wireless device. In response to the user device 122, for example, being within a proximate area of the location code 105 and detecting the location code 105 in response to being in the proximate area of the location 104 or scanning the location code, the user device 122 can be authenticated with an application 110 that can be on each of the network 106, server 124, data repository 130, platform management terminal 140, on the user device 122 itself, or another user device 120. The application 110 can then provide the user device 122 a set of tasks based on a status level of the tasks, a user ID of the user device 122, the location code 105, and the role of the user of the user device or user ID of the user device 122, for example. These tasks can be assigned, maintained or modified by the platform management terminal 140, the server 124, or another user device (e.g., 102, 122) or component operating as or in communication with the platform management terminal 140.

The QR code or RFID tag of the location code 105 can interact with the application 110 depending on the role that the user device 120 or 122 is assigned, currently performing and their historical experience in performing that role or user status. For example, a user or user device 120, 122 can receive a list of tasks to perform based on their assigned role (e.g., a prepper, housekeeper, manager, inspector or other role) and their level of experience in that role. Certain instructional information can be provided to a staff or user device scanning the QR code or sensing the RFID tag with a set of first tasks based on an experience level associated with the user or UE ID. An inexperienced user, for example, could be provided a more detailed list of activities to assist with training (e.g., “how to” instructions or video, along with instructions for using/performing certain items/tasks, as well as any associated inventory location). In comparison, an experienced user, or a user that has satisfied a threshold level of knowledge, employment or experience could be provided a list of stations and associated tasks to complete without a lot of additional detail. As the tasks are completed each user can update the tasks in the app by designating them as completed. Once the set of tasks or a certain number of tasks for the particular role and status level are completed, another status level (e.g., a location status and user status) could be activated for another user with a different role to engage the location code 105 at the location 104. Different roles and users with user IDs can be provided a unique work list for each employee at any one specific location 104 with a single location code 105 based on the status of the location or previous tasks that have been completed as inputted into the application via a user device within a same period of time or similar duration. Instructional information can be provided via the application to a user device 120, 122 with the set of first tasks to the first UE based on an experience level associated with a first user ID.

The system 100, user device 122 or application 110 can operate through the location code 105 of a location 104 for notification, escalation and tracking of various tasks assigned to be performed at the location 104. The system 100 can include configuring a customized workflow to provide notifications of work progress at each user role and location status level, as well as enable escalations when requested or due to negligence, along with a continuous tracking at the enterprise/entity management level or other user device 120 for each employee role and status level for any particular location 104.

For example, in response to the user device 122 completing a set of tasks assigned to the user ID of the user device 122, to the particular location 104 and to the location status level for the location 104, the user device 122 can update the tasks performance progress to complete, and thus activate another status level with particular tasks assigned to the location code 105 for the location 104. In an example, in response to the user device 122 completing prepping tasks, the user device 122 can communicate this to the network 110 after scanning the location code 105 so that the completed tasks are updated and another status level (e.g., housekeeping) can be notified to another user device 120 for performing tasks assigned for housekeeping at the location 105. These tasks could be modified based on a level of completion of the first tasks, requests from guests, a level of experience, number of staff or user devices scheduled on the premises for this day or specific time period, as well as a duration or period of time for completion, for example.

As depicted, system 100 can include user devices 120 or 122 as user equipment (UE), servers 124 as workflow application servers, data repositories 130, a platform management terminal 140, and the network 106. The number of devices and/or network, illustrated in FIG. 1, is provided for explanatory purposes only. In practice, there can be additional devices and/or networks, fewer devices and/or networks, different devices and/or networks, or differently arranged devices and/or networks than illustrated in FIG. 1.

Also, in some implementations, one or more of the devices of the system 100 can perform one or more functions described as being performed by another one or more of the devices of system 100. Devices of environment or system 100 can interconnect via wired connections 107, wireless connections 107, or a combination of wired and wireless connections 107.

UEs or user devices 120 or 122 can include any type computing device, such as a wireless mobile communication device, that is capable of communicating with network 106. For example, UE 120 can include a smartphone, tablet computer, laptop computer, wearable device, or other computing device. In some implementations, user devices 120 or 122 can alternatively include a desktop computer, a radiotelephone, a personal communications system (PCS) terminal (e.g., that can combine a cellular radiotelephone with data processing and data communications capabilities), a personal digital assistant (PDA) (e.g., that can include a radiotelephone, a pager, Internet/intranet access, etc.), a laptop computer, a tablet computer, a camera, a personal gaming system, a smart phone, or another type of computation or communication device. User devices 120 or 120 can include a camera or another type of image capturing capability for detecting and processing QR codes or RFID tags.

Application servers 124 can include one or more servers or other types of computing devices capable of gathering, processing, searching for, storing, and/or communication information as described herein. In some implementation, servers 124 can include an application server or a web server that stores one or more applications (e.g., application 110) and/or that permits the one or more applications to be accessed and/or downloaded by UEs 120 or 122. Application servers 124 can include a single server device, group of server devices, and/or one or more virtual servers. In some implementations, servers 124 can comprise a pin page platform as described herein. In some implementations, servers 124 in combination with one or more other types of devices, e.g., UEs 120, data repositories, platform management terminals 140, etc., can comprise a workflow application platform. Application servers 124 can include, or be connected to, one or more data repositories 130.

Data repositories 130 can include one or more data storage devices capable of receiving, storing, and providing data related to pin pages, pin page accounts, pin page usage information, etc. In some implementations, data repositories 130 can include a database or another type of data storage system or framework for organizing and storing data. In various aspects, servers 124 and data repositories 130 can be connected via network 106.

Platform management terminal 140 can include a type of wired or wireless user device capable of communicating with workflow application server(s) 124 and/or data repositories 130 via network 106. Platform management terminal 140 can include a smartphone, tablet computer, laptop computer, desktop computer, or another type of user device capable of enabling a user, operator, or developer to interact with workflow application servers 124 and/or the workflow application platform as described herein. In some implementations, platform management terminal 140 can be a UE or user device 120 or 122. Additionally, or alternatively, platform management terminal 140 can be directly connected to workflow application servers 106 via wired connections as well as wireless connections.

Network 106 can include a single network or multiple networks capable of enabling a connection between the devices of FIG. 1. Network 106 can include one or more wired and/or wireless networks. For example, network 106 can include a Bluetooth® network, a Wi-Fi network, or a cellular network, the Public Land Mobile Network (PLMN), and/or a second generation (2G) network, a third generation (3G) network, a fourth generation (4G) network, a fifth generation (5G) network, a sixth generation (6G) network and/or another type of network. Additionally, or alternatively, network 250 can include a wide area network (WAN), a metropolitan area network (MAN), an ad hoc network, an intranet, the Internet, a virtual network (e.g., a virtual private network (VPN)), a telephone network (e.g., a Public Switched Telephone Network (PSTN)), a Voice over IP (VOIP) network, and/or a combination of these or other types of networks.

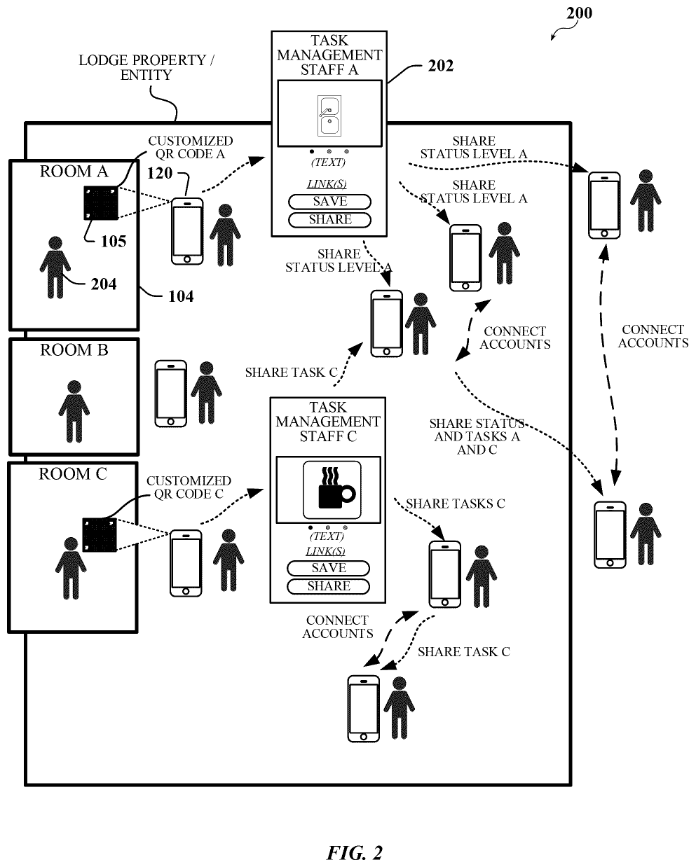

FIG. 2 is a diagram of an example overview 200 according to one or more implementations described herein. As shown, a lodge, property or other entity can include a variety of rooms (e.g., Rooms A thru C). Each room can represent a location (e.g., location 104 of FIG. 1) of property or entity 102. Each room can be staffed by room staff. Some rooms can include a picture, printout, or other display of a customized QR code or RFID tag associated with the room that covers a proximity are within the room or be sensed/scanned within the proximity area of the location 104. The customized QR code/RFID tag can function as a location code 105 that provides tasks that are designated to the physical location as the room, in which different QR codes/RFID tag can be associated with different locations, areas, or proximities of a geographical area having various sets of stations and their affiliated tasks for various status levels. As discussed, these tasks can be designated to each user depending on a status level of the room (area), as well as the user profile or user ID of the user device (e.g., user device 120). The QR code/RFID tag can be digitally associated with a workflow application 202 and an account, user profile or page that includes images or photos, videos, text information, and other information about the tasks and the location, or station, assigned to be completed for a particular room or location 104 within the entity 102. The user workflow application 202, or workflow application platform, can also include a page with hyperlinks to webpages, buttons for accessing other functionality, and other types of interface features that can designate and depict (e.g., in photo, video or text) the stations with tasks to be completed to the user for a particular status level or staff user.

For example, a page can be created, hosted, and provided in a display by a workflow application or platform associated with a general manager or an area manager profile, while other status levels can include a prepper, housekeeper, maintenance worker, or guest status level for guest interaction with front desk, host, or other staff for the guest user at the location 104. The workflow application 202 can include a photo or other visualization in a display to the staff or user of the location, the station or room associated with tasks to be completed, which may be included in the page or a report with additional assistance (e.g., task instructions, status level, tasks to be completed, other stations, locations, task assignments, enterprises or entities to be visited or associated with other tasks, manager or higher status level staff contact information, or information about supplies (e.g., cleaning agents, tools, supply inventory, etc.), for example.

The workflow application platform can enable anyone (e.g., even users without a staff account) to view certain pages after scanning customized QR codes, including providing a request or request opportunity in the workflow application of the guest UE with a guest profile that has been associated or authenticated to of the location based on the QR code or the RFID tag. In response to receiving a guest request from a guest profile that has been registered and associated with the QR code or RFID tag, a task can be added to a set of tasks for a particular status level or staff member. For example, a guest 204 or guest UE can scan the same QR code or RFID tag in the room and be provided a page with a graphical user interface (e.g., a requests button or inventory request button, text or chat option to communication or trigger for making guest requests. These guest requests can include inventory requests (toiletries, coffee, kitchen items, dish/laundry soap, or other inventory items), service requests (e.g., room service, conference/presentation scheduling, or other services or entertainment scheduled), maintenance requests (e.g., plumbing, electrical/mechanical repair, HVAC, or other maintenance), or other guest request services or products. Users with a workflow application platform account associated with the QR code/RFID tag 105 of their location can also be able to create a user profile, display a user profile place to other users on the platform, become connected with the user profiles of other users (also referred to herein as “connected users”), create private and public social network groups, message and forward pages to connected users on the premises, and fill out satisfaction surveys and make recommendations for improvement based on their satisfaction with the location 104. The workflow application platform can also enable users to create pages, associate pages with customized QR codes, instantly edit or modify pin pages, push update messages to users that have “liked”, “favorited”, or “saved” the pages, and so on. These and other features are described below in greater detail with reference to the figures that follow.

Each user device 120 associated with a staff member (employee) or guest can operate to scan or detect the QR code or RFID tag as the location code 105. QR codes or RFID tags can be provided across the properties or entities 102 at a variety of locations 104 focused on core needs at the entity, such as at public spaces (e.g., lobby, pool, gym, or the like), guest rooms (cabins, hotel rooms, extended stay rooms, resorts, or other lodgings), maintenance areas (e.g., janitorial closets, inventory bins, or the like), maintenance items (e.g., boilers, electrical panels, flammable storage cabinets, or the like), administration locations (front desks, help desks, lifeguard desks, or the like), or at safety items (e.g., fire extinguishers, inflatables, sprinklers, or other safety items). Standard responsibilities can be partitioned into a series or sets of tasks divvied up by the particular location and based on a status level of the location or a location status, as well as a user profile, user ID or user status.

Using the guest room/lodging example mentioned herein for illustration, a new employee or staff member assigned to work preparation (prep, prepper or the like) for Room A as an attendant to this location can scan the location code 105 in Room A while utilizing the workflow app. Preparation (prep, prepper or the like) can be one of the location statuses from status levels assigned to the location 104. Other location status of the status levels can include, but are not limited to, a housekeeping status level (housekeeping level), an inspection status level (inspection level), a maintenance status level, a guest request status level, or other division of labor assigned with tasks to a particular location 104 through the QR code/RFID tag of the location code 105.

Upon scanning the location code 105, the prepper can be provided a list of tasks that can include other information based on a level of experience, a level of training, a status level of a user profile, or a station within the proximity area of the location associated with the QR code or the RFID tag. For example, if the user is assigned the role or user status of a prepper, but is a new staff member or employee within a certain time period, then the user can be provided a training list along with tasks with step by step guides on what that the task process entails, including prepping activities as tasks to complete for the location 104. These prepping tasks can include, but not limited to, inspecting the door, checking the bed for bed bugs, inspecting each station within the guest room, stripping the bed, sweeping the floors, clearing out trash, leaving fresh linens, and marking the tasks as complete within the workflow application 202, for example. Alternatively, or additionally, a more experienced prepper could be assigned prepping tasks without a lot of detail training information, or even different tasks based on his or her level of experience or training completed. Tasks can be custom fit based on the current needs of the business, and skillset of the individual performing the activity.

Following successful completion of the prepping tasks in Room A, the housekeeper assigned to the room can be notified via the workflow application that the room is ready for further cleaning or housekeeping tasks. An experienced housekeeper could have a high level detail of tasks to complete, or different tasks compared to one that is less experienced or with less training. Similar to the other status levels or user status, the housekeeper can be provided a list of stations to validate in the workflow application as the tasks are completed, with a list of specific subtasks by station, if they so desire to review. If issues are encountered that are not applicable to their job duties (e.g., the air conditioner not working in the room), the housekeeping user can log the issue and escalate it to another user assigned another user status of a status level, such as the General Manager user, who can reassign the maintenance ticket as needed internally. Once the Room A has been cleaned, the housekeeping user can mark the room complete and the General Manager user can receive a notification that the room is ready for inspection as an inspection status level for the location 104. In this manner, the location 104 can be assigned location statuses of status levels and each user assigned to the location can be assigned one or more user statuses with particular sets of tasks for each location status designated to the location 104.

Based on a user status and the location status for the location 104, each user can be notified and location status updated in response to detecting, scanning or identifying the QR code/RFID tag at a particular location. For example, Room C can have the customized QR code/RFID tag for this location activated for inspection by a General Manager user. Once the General Manager or inspection user assigned to Room C scans or detects the location code for this location, the inspection user can receive inspection tasks and update them as completed after each is completed. Any task not passing inspection or receiving feedback, can then be processed in a notification shared to the other designated users (e.g., the prepping user with room preparation tasks, or the housekeeper user with housekeeping tasks). For example, if the housekeeping user failed to adequately pass a task inspection, the particular tasks along with any feedback from the inspection user can be notified to the housekeeper user via the workflow application 202. The housekeeper user can then return to the room or location (e.g., Room C) and complete the tasks that did not pass inspection or mark that the notification was received, for example. Once the room or location passes all inspection tasks, or prepping tasks, housekeeping tasks, any guests requests, and inspection tasks are marked as complete, the location with the location code can be marked with or indicate an active status for receiving another guests or further guests requests (when there are tasks that include any active guests requests) for the location. Therefore, any detection, scanning or identification of the location code 105 at this particular location can indicate the tasks or activities completed with an active status for further guests or guest requests, in which no further tasks are being assigned to the location at this time.

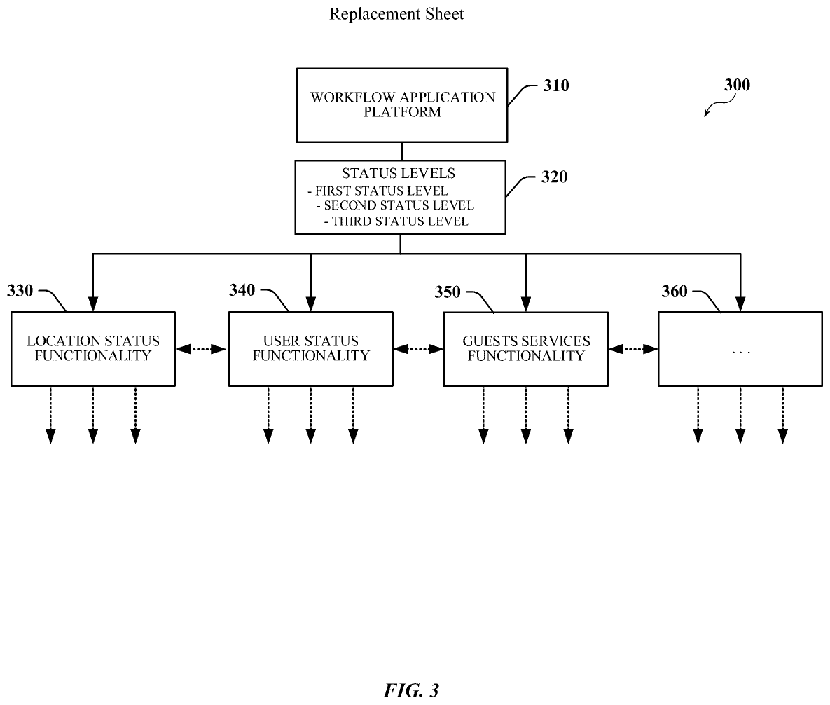

FIG. 3 illustrates example functionalities 300 of the workflow application associated with various status levels and their assigned tasks corresponding to locations codes of various locations. As shown, workflow application platform 310 can function to designate and activate status levels 320 that can be arranged in a hierarchical order such that an initial status level is pre-eminent or takes precedence before the next second status level, and so on with the third, fourth or other status level. In response to scanning, detecting or identifying the QR code/RFID tag of a location and a user profile, user ID or user status detecting this location code, various functionalities related to the status levels 320 can be provided to the user device. In particular, the workflow application or workflow application platform 310 operates the status level at a location according to location status functionality 330, user status functionality, guest services functionality, as well as other functionalities that can include an ad hoc functionality based on seasons, scheduled events in the area of the property or entity, events on the property or entity, as well as daily tasks, weekly tasks, monthly tasks, quarterly tasks, annual tasks, or other association in time.

In some implementations, one or more of functionalities 330, 340, 350 and other functionalities 360 can be performed by one or more of UEs 120, 122, server 124, and/or platform management terminal 140, and/or one or more other types of devices described herein. Additionally, the workflow application platform 310 can include one or more fewer, additional, differently ordered and/or arranged groups of functionality than those shown in FIG. 3. As such, FIG. 3 is provided as a non-limiting example of workflow application platform 310 and an arrangement of operations, functions, and services thereof.

Functionalities 330, 340, 350 and 360, for example, can each represent operations, functions, and services supported by workflow application platform 310.

For example, location status functionality 330 can include operations for creating tasks associated with the particular location, creating descriptions of the tasks for each location, monitoring functions at the location, and what tasks are to be associated with various user statuses in a hierarchical order of operation. User status functionality 340 can include operations for enabling an individual to scan the QR code/RFID tag, access a corresponding page or set of tasks associated with the location and their status descriptions (e.g., details associated with the tasks, whether they are active/inactive to initiate, and their progress), share the page with others, or other user operations. Guest services functionality 350 can include operations for managing guest accounts, security, guest requests, and their associated progress functionality, data collection, storage, and processing. Additionally, or alternatively, one or more portions or aspects of functionalities 330, 340, 350, 360, can interrelate or overlap with that of one or more other portions or aspects of functionalities 330, 340, 350, 360. Each of functionalities 330, 340, 350, 360 are described below in greater detail with reference to the figures that follow.

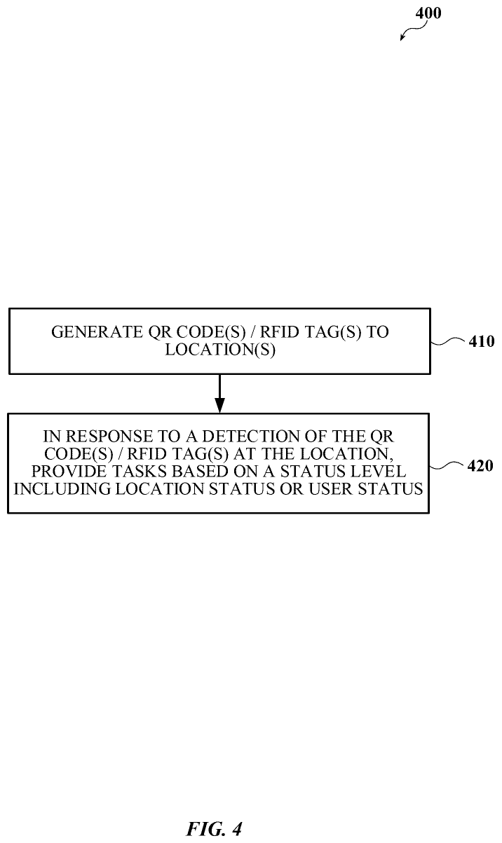

FIG. 4 illustrates an example process flow 400 for a workflow application according various aspects described herein. The process flow 400 initiates at 410 with a user device, server or terminal generating location codes including QR codes/RFID tags associated with locations, respectively. Each location can include a single QR code/RFID tag for user devices to detect, identify or scan. At 420, in response to detecting the QR code/RFID tag within a proximity area of the associated location, the user device can be provided sets of tasks that are enabled/activated based on the status level of the location, including the location status level, and the user status level with a user profile or user ID. The location status level can be dependent on the sets of tasks and which sets of task have been completed, and the user status can be dependent on a user profile, user ID or user status upon physically scanning the QR code/RFID tag at the location. Once the QR code/RFID tag is detected, a user ID of the user device can be processed identify the set of tasks assigned for the user to complete at the location and indicate which portion of the tasks or all the tasks that are activated to be completed. If a first status level is activate, then prepping tasks can be provided. If the second status level is activated when the first status level tasks are completed, then housekeeping tasks can be provided. If the first and second status level tasks are completed, then an inspection status level can be activated. These status levels are examples of a status level hierarchy that can be provided and activated based on one another's completion and the scanning of the QR code/RFID tag, for example. Other status levels can be envisioned, including guest services/requests, maintenance status, front desk services, area manager, other managerial tasks, or the like.

The process flow 400 can further include assigning, or performing, via the third user profile, the status levels from among the various status levels to a user device, user ID or user status, and to the QR code or RFID tag of the location. For example, if one person is sick this day and does not arrive for work, another user ID or user status can be assigned and performed based on their assignment to the location and when detecting/scanning the QR code or RFID tag. This third user profile or user device can be a general manager user status and operate to activate any status level following a first status level of the plurality of status levels upon completion of a set of tasks of a preceding status level. The different sets of tasks assigned to a status level (either a location status level or user status level) can be based on one or more of: a level of experience, a level of training, a status level of a user profile, or a station within the proximity area of the location associated with the QR code or the RFID tag, for example. A notification can be provided to another user profile in response to an activation or a completion of the set of tasks, a maintenance requests, or other managerial requests for property, employment or other issue arises in escalation with respect to the location.

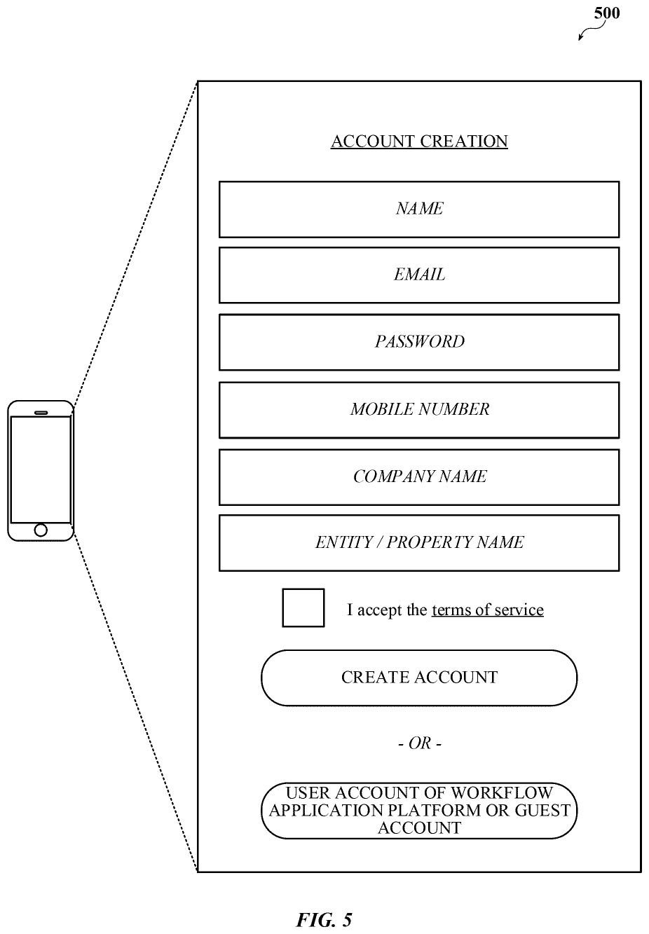

FIG. 5 is a diagram of an example user interface 500 for creating a workflow application account or profile according to one or more implementations described herein. In some implementations, one or more of the features of user interface 500 can be provided via one or more additional or alternative user interfaces. Additionally, one or more of the features of user interface 500 can include fewer, additional, differently ordered and/or arranged features than those shown in FIG. 5. The examples of user interfaces are non-limiting examples of user interfaces that can be involved in one or more implementations described herein.

A user interface for creating a user account for the workflow application can include one or more interface objects, such as text boxes, dropdown menus, radio buttons, press-able buttons, check boxes, URLs, instructions, prompts, graphics, etc., to enable or facilitate the creation of a user device account for a staff employee role or user status level, as well as a guest account for a guest status. As shown, user interface 500 can include text boxes for entering user information, such as a username, email address, password, mobile number, company name, an entity/property name or various locations. User interface 500 can also include interface features for accessing terms of service (e.g., via a URL) and indicating acceptance of the terms of service (e.g., a check box). In some implementations, a user can create a workflow application account by filling in such information and selecting a “create account” button or by selecting a button to login to into an account the user can have on an alternative platform (e.g., a social media account). In such a scenario, the workflow application platform can retrieve user information from the alternative platform and automatically create a workflow application account for the workflow application platform. A workflow application user account can also be referred to herein as a workflow application user account, a user account, or the like.

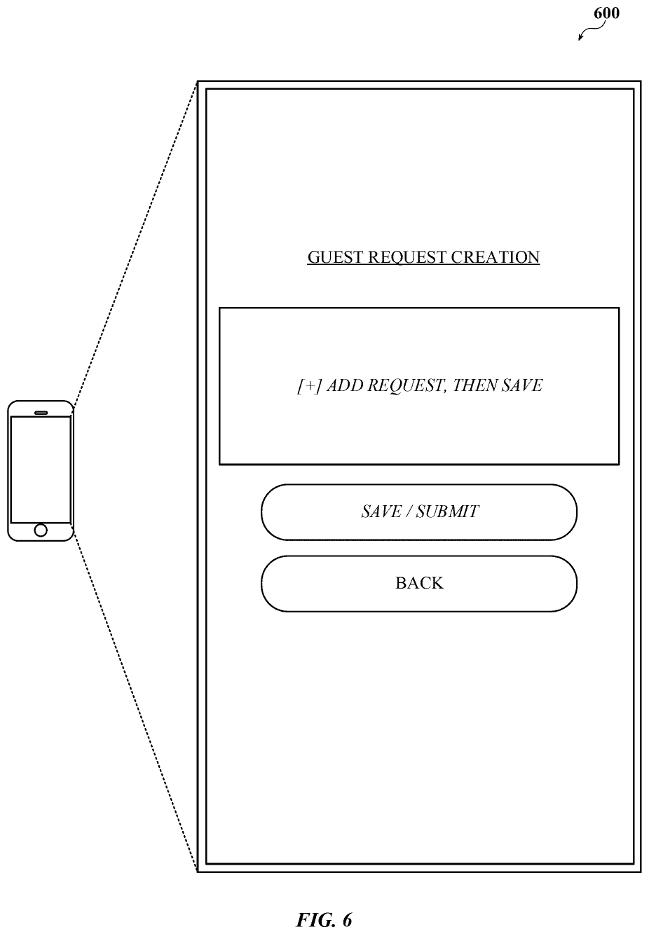

Alternatively, or additionally, a guest at a location can create a guest account to enable requests to be made at the location upon scanning the QR code/RFID tag at the location with the guest account as illustrated in FIG. 6 with a guest user interface 600. The guest user can scan the location code including the QR code or RFID tag in their room location, then submit ticket requests for maintenance of any items within the room or for service to the room (e.g., food/drink delivery, purchases of items, coffee refill, or any other service to the room). The ticket then can be provided to the appropriate staff role or user status to be fulfilled. Once the staff or user enters the room, the user can scan the QR code/RFID tag to enter that the requests has been fulfilled and no longer pending for the location code that is unique to the particular location. Once fulfilled and any maintenance or service request is no longer actively pending, notification can be provided to the guest user as well as to another user such as the inspection user or other manager user, for example.

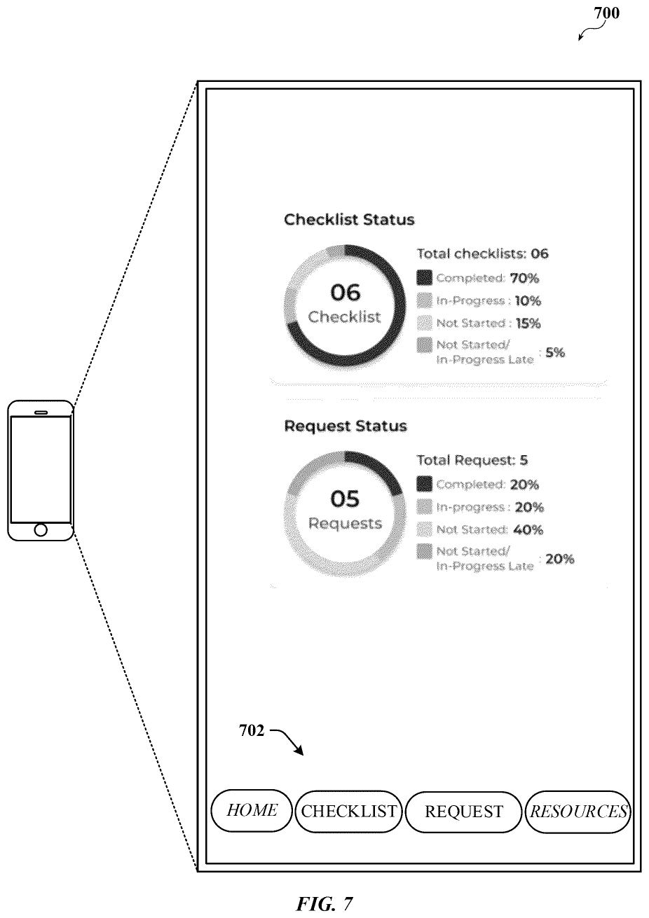

FIG. 7 illustrates another example user interface 700 for the workflow application according to one or more implementations described herein. As described above, the workflow application can be configured to respond to user devices scanning a QR code or RFID tag that is unique to a particular location. Although the location has been described in examples as a room (e.g., a hotel, extended stay room, resort, lodge or other overnight stay location), the location can also be a public space providing general access to particular webpages based on the location. Individuals or guests can receive information about the surrounding shops, activities, facilities, help desk information, maps based on their location in the public space (e.g., lobby, parking lot, walkway or other space around or within an entity/property), or other information. Additionally, rooms can be locations as well as certain safety items with a unique QR code or RFID tag from among other locations.

Each room can have a set of tasks that corresponded to roles (certain user statuses) designated by the general manager user status and enable unlocking or activating assigned tasks for particular locations upon scanning/identification/detection of the QR code or RFID tag within a proximity area at the location. These tasks can be provided with various parameters, such as a designated time period for performance and completion as well as a progress status.

The interface 700 includes a checklist status and requests status as an example with progress statistics for those tasks in the checklist that are completed, in-progress, not started, or behind schedule on, as well as user interface controls 702. Additionally, the request status for guest requests can also be provided with similar categories or statistics as the checklist status in the interface 700. The user device assigned these tasks scans the QR code/RFID tag, the user can be provided a dynamic update of their goals for the day with associated tasks to their user status level for the location and updated based on level of completion. Based on their progress, the next location status can be activated for a follow up staff user or user device with a different user status level to follow-up with other tasks associated with the same location based on his or her user status level, the previous tasks being completed, any additional or outstanding requests, associated or designated parameters (e.g., time frame, date, season, local activities or events, or the like), or level of experience and training. In this manner, various room locations or locations in general could only have those who are properly authenticated to work at these locations with these assigned responsibilities or tasks for a particular status level are found at the location or working at the location, and the workflow of tasks or responsibilities can be monitored and dynamically modified or updated through the workflow application platform. Different users or people can have different layers of responsibilities for one location with one unique QR code/RFID tag associated with the location for a variety of circumstances.

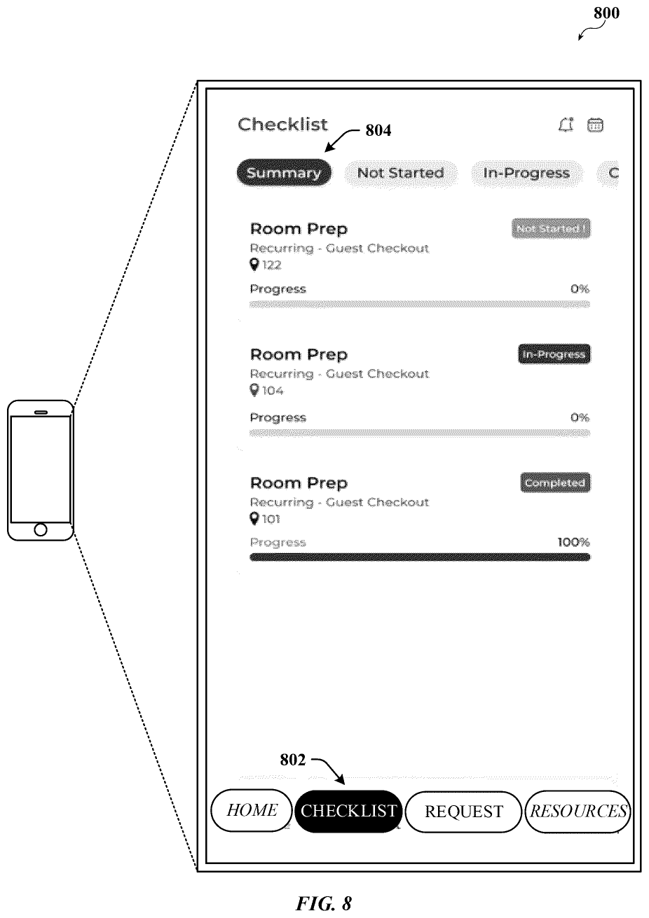

FIG. 8 illustrates another example user interface 800 for the workflow application according to one or more implementations described herein. Here, a summary of tasks and their progress can be provided based on the location (e.g., Room 122, Room 104, or Room 101) through the checklist interface control 802 and a summary tab 804. The interface 800 can indicate whether the room has been started, in-progress or completed regarding associated sets of tasks assigned to the location and user profile, user ID or user status.

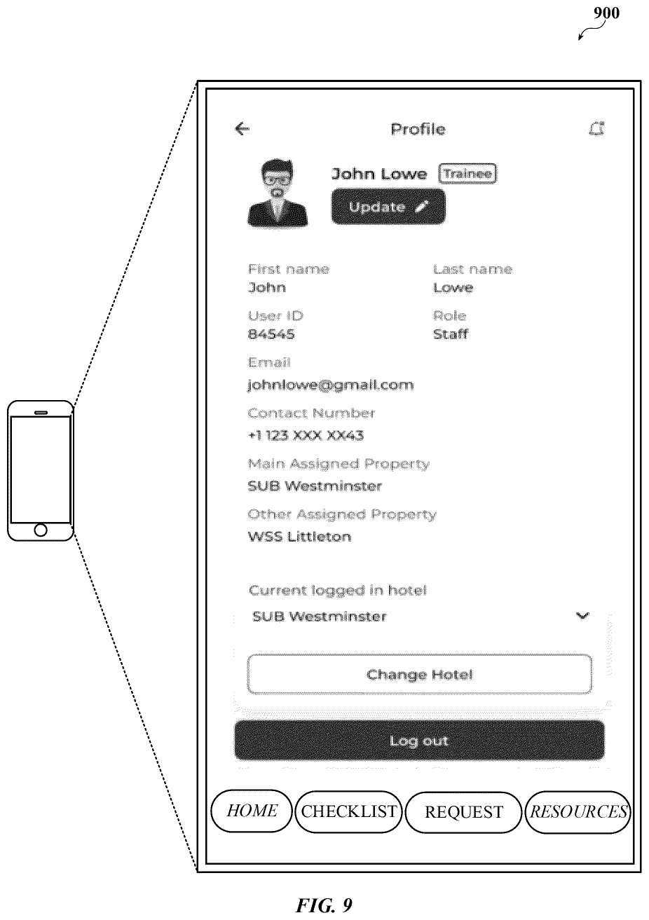

An interface 900 of FIG. 9 illustrates an example user profile with their level of experience (e.g., Trainee, Employee, Senior, Veteran, or other higher level) along with the various entities or properties the user is affiliated with and logged into for performing any assigned tasks. The user is able to change the entity or property (e.g., logged in hotel) by logging out of one entity and into another. The user profile includes a user ID and user role (e.g., maintenance staff, prepper, housekeeper, inspector, or other role) associated with the user ID.

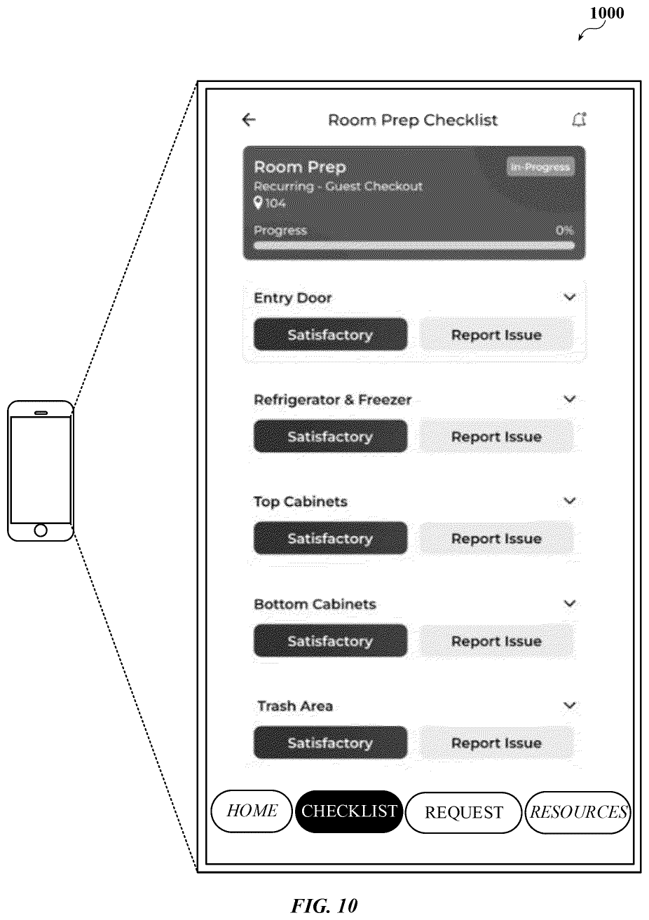

FIG. 10 illustrates another example interface 1000 with a set of tasks provided in response to scanning the location code of a location in an entity. Here, the location is room 104 involving a guest check out. When the guest check out involves an extended stay check out, a prepper can be assigned the initial status level before other users with subsequent status roles and associated tasks are activated. Room prep, for example can include a checklist of stations that can be unique or similar to other locations, including, but not limited to, entry door, refrigerator and freezer, top cabinets, bottom cabinets, trash area, or other station with associated station tasks within the proximity area of the location. Other station tasks can include examining the bathroom door, the wall behind the bathroom door, the mirror and sink, toilet, tub area, electric panel wall, floor (carpet, tile and laminate), as well as final steps before leaving the room, or the like. Other station tasks of a location can include a trash area, a desk area, a TV, closet space, Window and packaged terminal air conditioner (PTAC), wall by window, nightstand area, wall behind bed, or wall next to bed, for example.

After scanning the unique QR code/RFID tag for the location, and the user with prepper status receives a set (one or more) of tasks associated with the location, the user can mark various stations as complete (satisfactory) or report any issues with the “Report Issue” button. Each station or task can have a description along with details for training or other notes such as in a drop down arrow on the upper right of each task or station tasks.

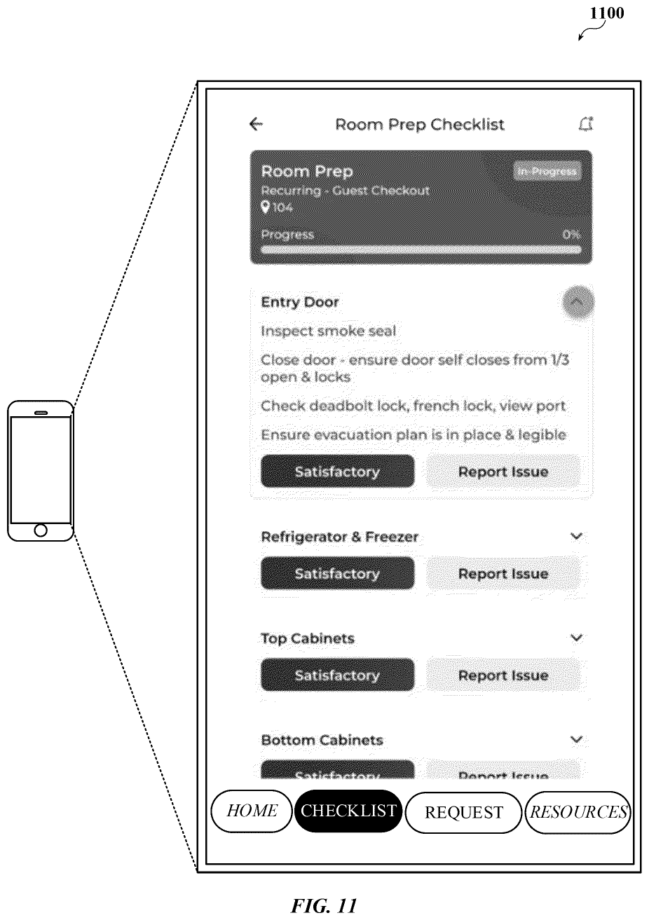

For example, at the interface 1100 of FIG. 11, the “Entry Door” station provides a list of tasks that includes: inspect smoke seal; close door; check deadbolt lock, French lock, view port; and ensure evacuation plan is in place and legible. Each of these tasks can be checked off within the interface or all of the tasks associated with the entry door station could be checked as completed. Some tasks can have additional information associated with it, including videos, tutorials, webpages or other documentation. For example, the task of close door in the entry door station provides reminder to ensure the door self closes from ⅓ open and also locks. Likewise, the other stations and associated tasks to the station for the location can have associated tasks and information to track the progress of their completion or any issues.

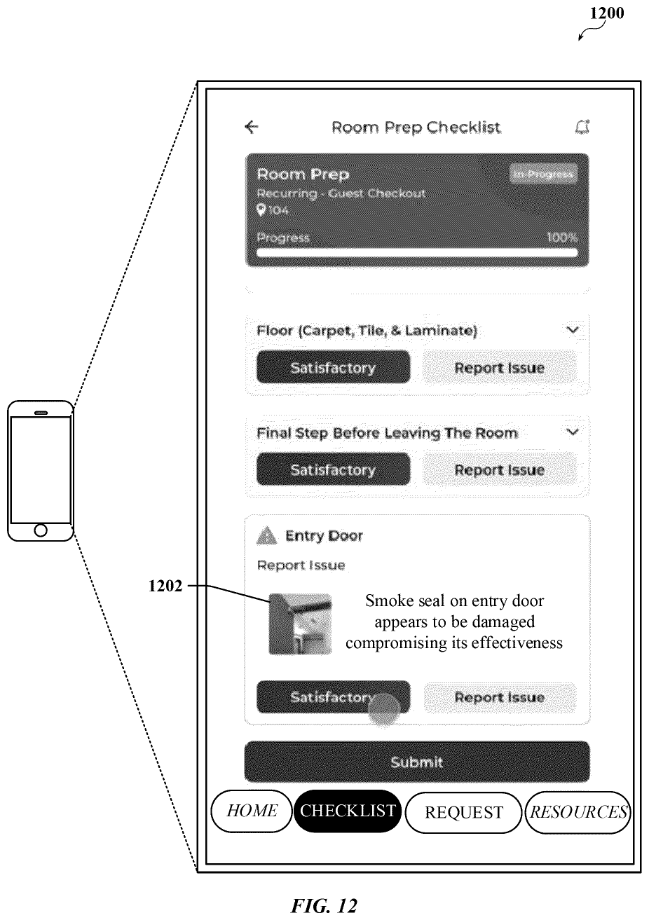

FIG. 12 illustrates an example interface 1200 for reporting any issues associated with any tasks or stations of the location via a report issue interface 1202. Here, in response to “Report Issue” interface control being selected, a picture of the station or associated tasks can be taken and submitted along with any commentary or description of the issue. If the location or station of the location does not have any issues to be reported, then the station(s) of the location could be selected or marked as satisfactory for completion by the interface control button “Satisfactory” and the progress updated in the workflow application.

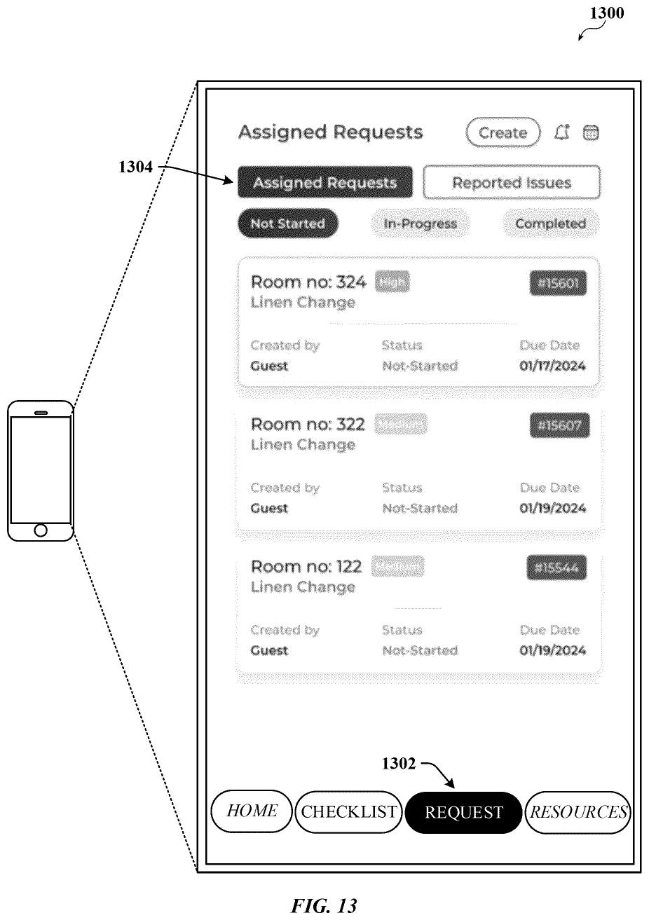

In response to guests request or any reported issues being associated with a room that is assigned to the user of the user device 122, for example, the user can be provided assigned guests requests or other managerial requests under the request page 1300 via the request interface control 1302 as illustrated in FIG. 13. The user can activate and update assigned requests with the location by scanning the QR code/RFID tag as they are performed or completed so that a progress and tasks can be appropriately monitored and managed based on user status level or role expectations. The assigned requests at the assigned requests control 1304 provides all guests/managerial assigned requests to be fulfilled by the user, as well as those not started, in-progress and activated by the location code at a location, and completed as indicated by a scanning of the location code again or marked/indicated as such in the application by any one of the user status levels or user roles via a user ID or profile.

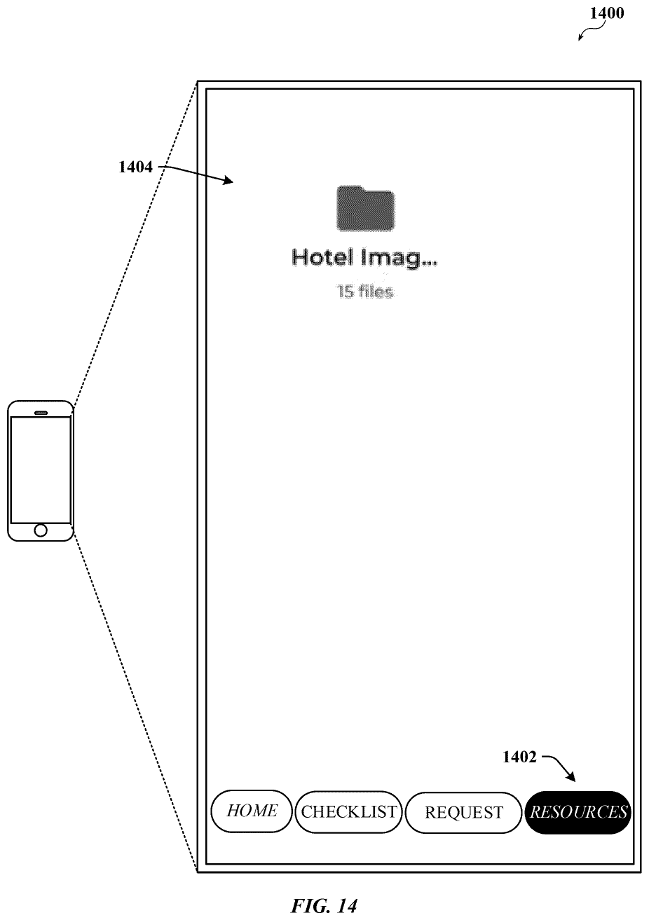

FIG. 14 illustrates another workflow application interface 1400. The resources control 1402 can operate to provide any images, files 1404, training information, schedules, procedures, forms, maps or the like for operation of duties at the various locations of the entity, including prepping, housekeeping, interfacing with guests, fulfilling guests requests, managing guests or other staff members, for example.

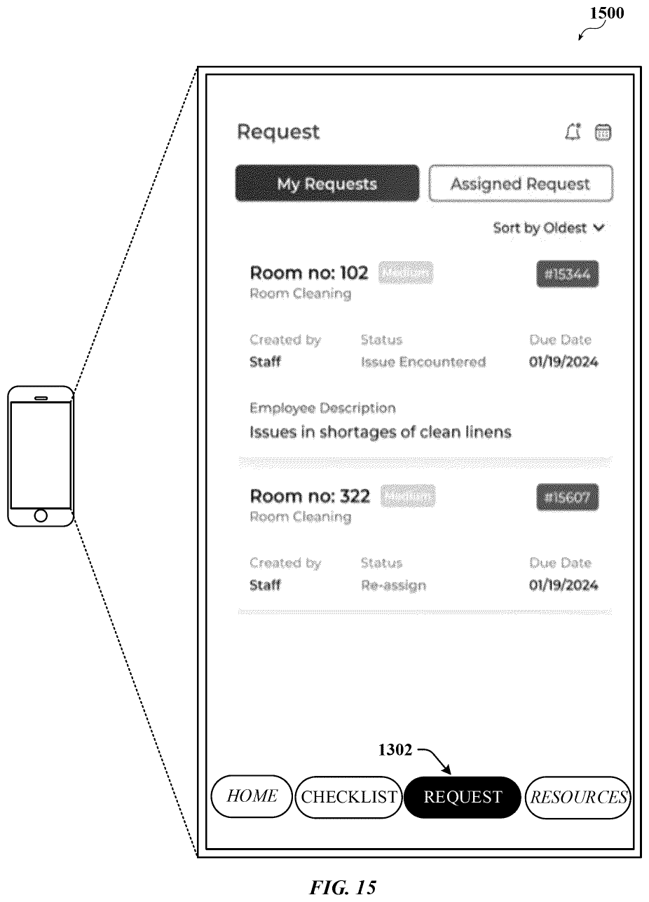

FIG. 15 illustrates another workflow application interface 1500. The resources control 1302 for requests also enables the user to create requests based on the user status level. When the user is an employee or staff member, the create control of FIG. 13 can be accessed, or another interface control, and used to submit needed requests for the staff member or other employee. These requests can include any number of requests associated with a particular user role, tasks or duties to be performed, scheduling, or the like. For example, a user housekeeper may report or request clean linens be provided or supplied to the room to complete certain tasks assigned for the location. Where time may be of the essence or a staff member may need help, a room or location could be requested to be re-assigned, for example.

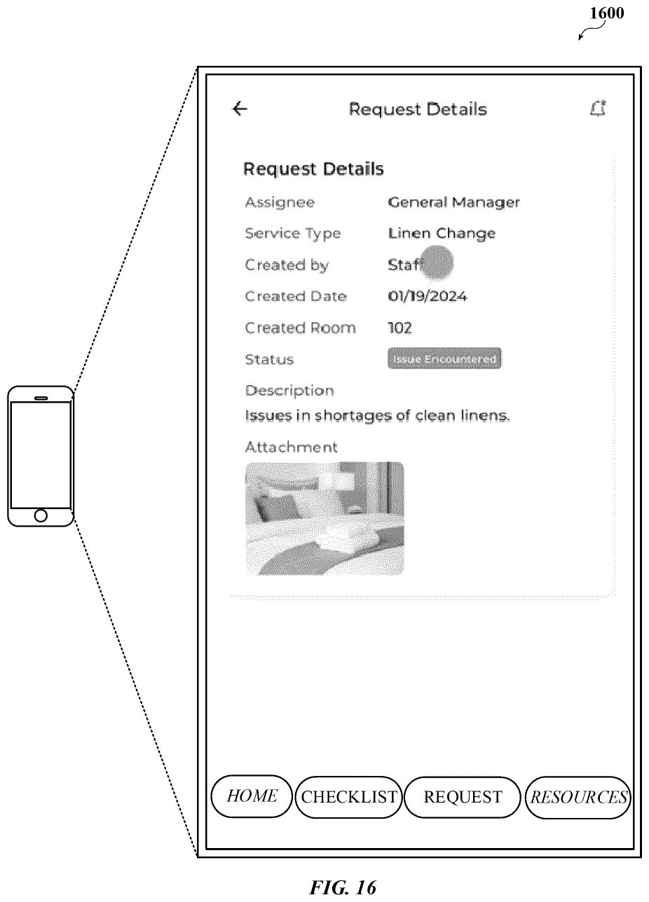

FIG. 16 illustrates an example of another workflow application interface 1600 with additional request details. A request can be staff/employee or other user status level request or guests request for services. Following along with the example for creating requests by a staff member in FIG. 15, Room 102 can be reported as having a shortages of clean linens, for example. The request for clean linens can include a picture of any issue, as well as the location number, date created, who created the request, the type of service and the person receiving the requests (e.g., General Manager). The general manger can then follow-up with the request by fulfilling the requests or reassigning the request to an appropriate user status level (e.g., a prepper, other housekeeper nearby, inspector or other user status) to follow up with the request.

In other aspects, the various user status level (e.g., preppers, housekeepers, inspectors, or other role) can receive a digital reward tracking in the form of a digital, badge, puzzle piece, ribbon, or other award for advancing their status level, experience, or training level dictating their level of responsibilities. In this manner, the workflow application can include gamification of the tasks and locations each status role is assigned to for a given period.

In an aspect, checklist or sets of tasks can be tied to a hotel location and vary from among hotel locations. Some sets of tasks or checklists can be the same, depending on the entity or property of the location and nature of business. The checklist or sets of tasks can be modified or reconfigured on an ad hot basis so that an ad hoc checklist can be provided to the user based on the location or the entity with many locations. For example, when a total eclipse is being observed, a special concert, political event or other geographical occurrence, various task can be centered around such an event and the various tasks assigned to a location can be modified to accommodate such events for guests at the entity. In another example, certain locations or entities of locations can require seasonal tasks, such as winterization (e.g., pipe covering, window sealant, or other winterization tasks) tied to a particular time line or set of dates for completion by.

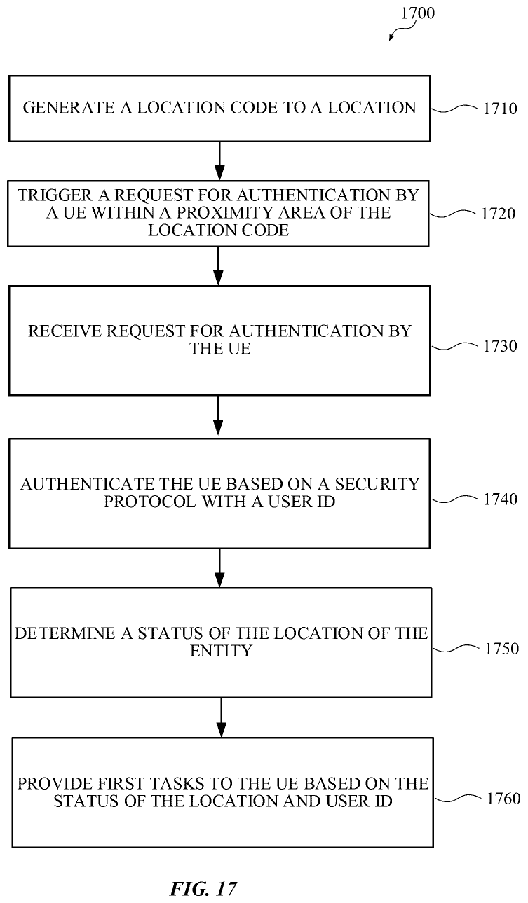

FIG. 17 illustrates another example process flow 1700 for a workflow application that utilizes location codes such as a QR code or RFID code to create, monitor and control the flow of work related tasks for users of various roles or user statuses to manage. The process flow 1700 initiates at 1710 with generating a QR code/RFID tag corresponding to a location of an entity for one or more UEs. At 1720, the process flow 1700 further includes triggering a request for authentication by a first UE based on the QR code or the RFID tag within a proximity area of the QR code or the RFID. At 1730, the process flow 1700 further includes receiving a request for authentication by the first UE. At 1740, the process flow 1700 includes authenticating the first UE based on a security protocol based on a first user ID. The security protocol can be a two-factor authentication or other security protocol for the workflow application to recognize the user profile scanning the location code and associate various tasks based on the user role and the location. At 1750, the process flow 1700 further includes determining a status of the location of the entity. At 1760, the process flow 1700 further includes providing a set of first tasks to the first UE based on the status of the location and the first user ID.

The process flow 1700 can further include modifying the status of the location of the entity from a first status level to a second status level associated with a set of second tasks that differ from the set of first tasks in response to receiving one or more indications of a completion of the set of first tasks. A second UE can be authenticated based on the QR code or the RFID tag at the same location. Then a set of second tasks can be provided to the second UE based on a second status level, or a level of completion of a set of first tasks associated with the first user ID, along with a second user ID of the second UE. Further, a third UE can be authenticated based on the QR code or the RFID tag at the location. Then a set of third tasks can be provided to the third UE based on a third task level or a completion of a set of first tasks and a set of second tasks at the location that correspond to a first UE and a second UE, respectively, as well as on a third user ID associated with the third UE.

In response to the set of first tasks being indicated as completed from the first UE, notifying a second UE to activate a set of second tasks by scanning the QR code or the RFID tag at the location and perform the set of second tasks based on one or more parameters comprising at least one of: a period of completion, instructional training information, location information, any reported issues, an inventory of supplies, or stations of the location. A progress of the set of first, second or third tasks can be tracked based on the location with the location code.

In an aspect, a guest UE can be authenticated with the location based on the location code unique to the location (e.g., a QR code or the RFID tag). The request for a task to be completed at the location of the entity can be received via a wireless link in response to a submission by a guest staying at the same location. A set of tasks associated with the location and a user status can then be modified based on the request and completed by assigning the requests to be completed once activated by the user status of a user device at the location and any previous status level tasks being completed. One of the UE can then be notified of a modified set of first tasks or a modified set of second tasks, respectively.

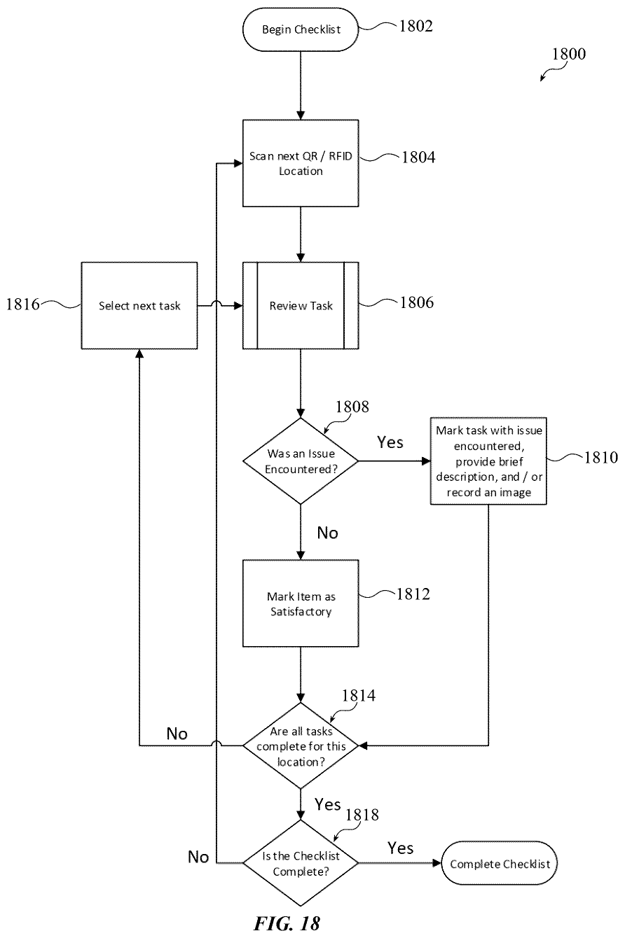

FIG. 18 illustrates another example process flow 1800 for a workflow application. At 1802, the process flow initiates with beginning a checklist such as for a set of tasks or jobs at one or more locations. At 1804, the process flow 1800 includes scanning a next QR/RFID location. At 1806, tasks are provided and reviewed in response to the scanning. Then at 1808 a determination of whether an issue is present or not in relation to the task(s) or the location is made. If the decision is “yes”, the process flow 1800 flows to 1810 where a task is marked with the issue encountered, which may include providing a brief description and/or recording of an image or photo from a UE device. The photo may include an image of the location or the station for tasks, or each individual task and its location, along with information for additional assistance with completing the tasks in a report, for example, or in a page with other information, including status level, staff ID, sets of tasks, assignment of tasks associated with the staff user's status level or below and their level of completion, or other information as disclosed herein.

After marking and recording the issue at 1810, the process flow 1800 flows to 1814 to determine whether all tasks are completed for the particular location. If the decision at 1808 is “no”, the process flows to 1812 with marking the item or associated tasks as satisfactory. The process flow 1800 then proceeds to the decision at 1814 to determine whether all tasks are completed for the particular location. If not complete, the process flows to 1816 to select the next tasks to work on, and initiates back to reviewing the task at 1806. If the tasks are complete (“yes” at decision 1814), the process flow 1800 moves to a decision 1818 to determine whether the checklists are complete. If the checklists are complete, then the process flow ends with a completed checklist, but if the checklists are not complete, the process flow 1800 moves back to 1802 to begin a next or additional checklist at the same location or another location.

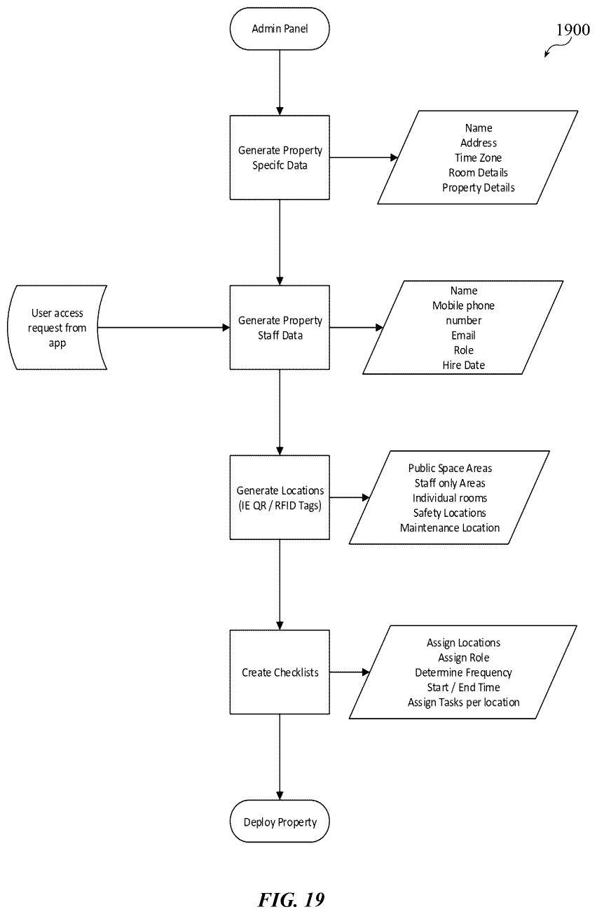

FIG. 19 illustrates a process flow 1900 for creating checklists and deploying a workflow application to one or more properties. An admin panel can be used to generate property specific data (e.g., extended stay lodging at a particular city), generate property staff data, generate particular locations in association with a QR code or RFID tag, and creation various checklists. A user is able to request access from the workflow application and track the different data, updates of data and make updates via the QR code or RFID tag, for example. The property specific data can include name (e.g., guest(s), assigned staff, location(s), etc.), address, time zone, room details (e.g., stations, partitions, items, or other property, etc.), and property details (maintenance items, other properties, appliances, utilities, etc.). Property staff data can include staff names associated with the property or location(s), mobile phone information (e.g., number, handle, username, etc.), email, assigned role or division of labor, hire date, level of experience or the like. The locations can include public space areas, staff only areas, individual/guest rooms, safety locations, maintenance locations or items, and the like. The checklists can include assigned locations, assigned roles, frequency of care including start/end time assigned, tasks assigned to the location and the like. The network can then employ the application to the property network/device infrastructure for workflow operations.

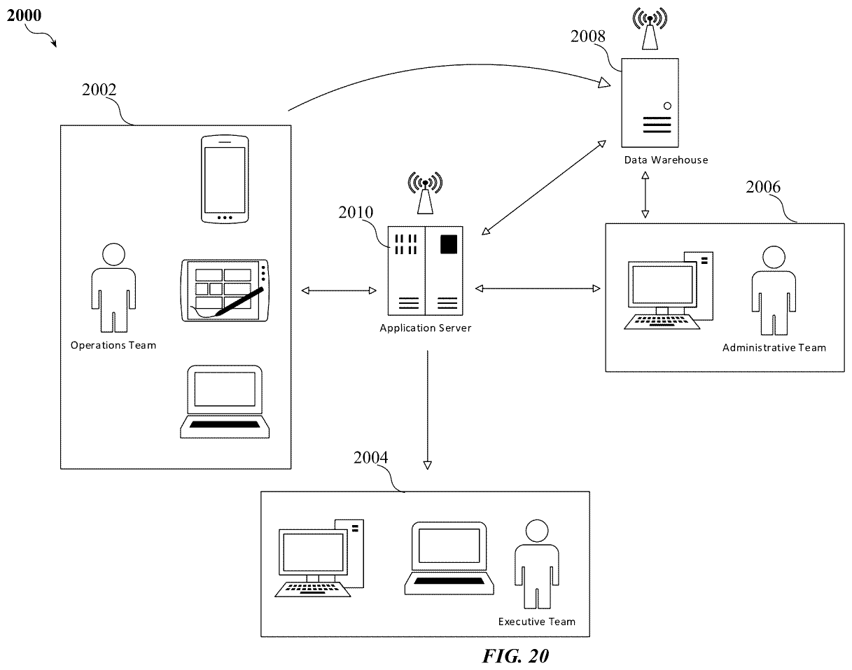

FIG. 20 illustrates an example of a communication protocol 2000 of the workflow application. The communication protocol 2000 can include an operations team 2002, an executive team 2004, and an administrative team 2006 that interface with an application server 2010 and a data warehouse 2008. The data warehouse 2008 can be a centralized repository that stores structured data (e.g., database tables, Excel sheets, or other data sets) and semi-structured data (e.g., XML files, webpages, and other site information) for the purposes of reporting and analysis. The data flows in from a variety of sources, such as point-of-sale systems, business applications, and relational databases, and it is usually cleaned and standardized before it hits the warehouse. Because a data warehouse can store large amounts of information, it provides users with easy access to a wealth of historical data, which can be used for data mining, data visualization, and other forms of business intelligence reporting.

The operations team 2002 operates with a network device to maintain checklists from FIG. 19 to an application server 2010 and a data warehouse 2008. The operational team 2002 interfaces with the data warehouse 2008 for updating or maintaining tasks, locations, and properties via the workflow application, for example. Each of the tams including staff, network devices, firmware and software interface with the application server 2010, which can be based on a cloud network or a server at a local property.

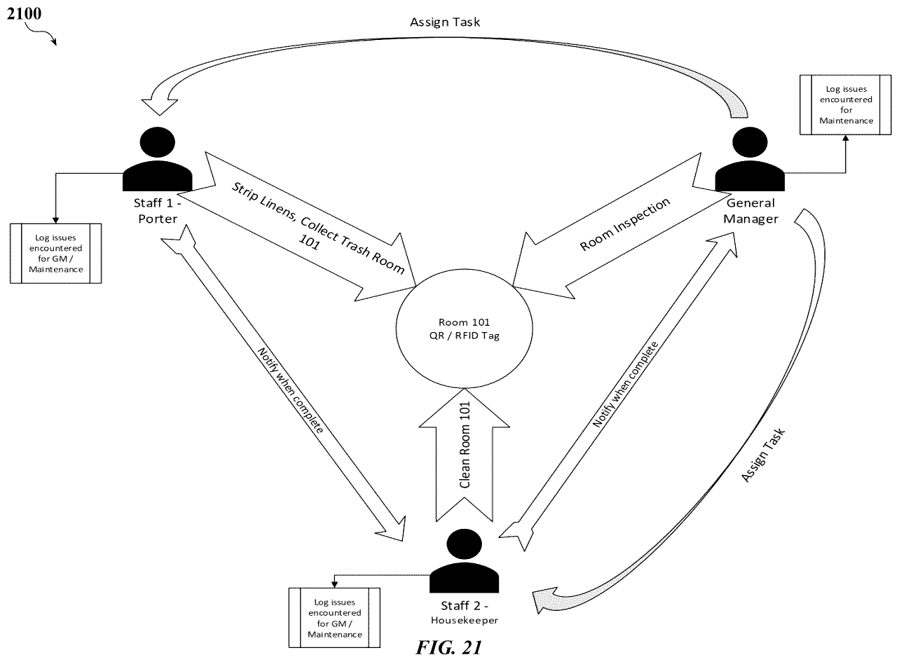

FIG. 21 illustrates another example workflow 2100 for a workflow application. A Staff 1 as a porter or guest attendant can be a division of labor that logs issues encountered for a general manager or maintenance staff, for example. A prepper or preparation attendant, as well as other divisions of labor, can also be included, and the current example of FIG. 21 is not limited to any particular set of divisions of labor for a property or set of locations. Additionally, a housekeeper can be notified by the staff porter when their division of labor or assigned tasks (e.g., stripping linens, collecting trash, or other tasks for an assigned location such as Room 101) are completed. Staff 2 (e.g. a housekeeper) can then log any issues encountered to the general manager (GM) or maintenance staff. After cleaning the room or completing the assigned tasks to the location (e.g., Room 101), Staff 2 can notify the inspector or GM for a room inspection or other corresponding tasks to be performed. The GM or Staff 3 can then report or escalate any issues, as well as assign, modify or complete any assigned tasks for the location (e.g., Room 101) or other locations at the same property or other properties.

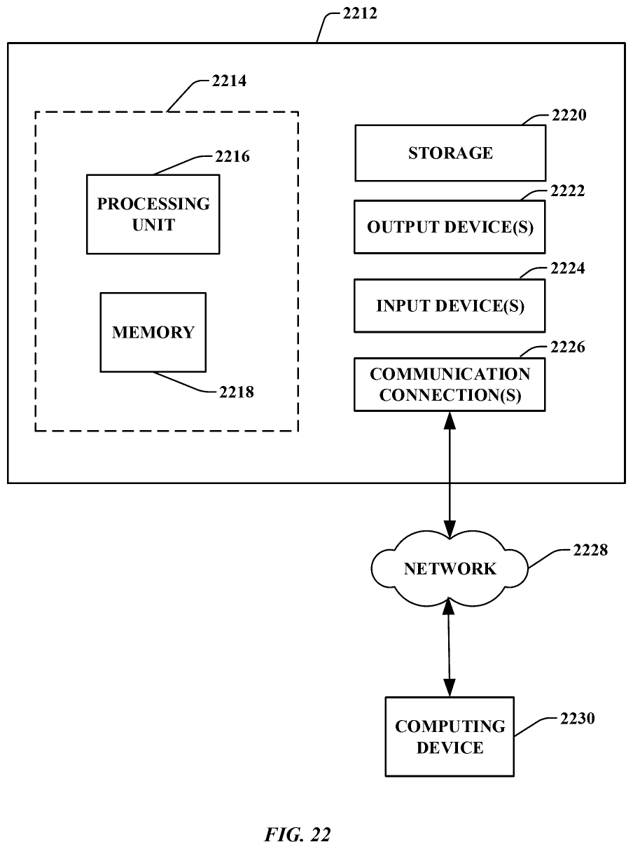

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting aspects, i.e., anywhere that a device may wish to engage on behalf of a user or set of users. Accordingly, the below computer described below in FIG. 22 is but one example of a computing device.

Although not required, non-limiting aspects can partly be implemented via an operating system, for use by a developer of services for a device or object, and/or included within application software that operates to perform one or more functional aspects of the various non-limiting aspects described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 22 and the following discussion provide a brief, general description of a suitable computing environment to implement aspects of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. The aspects described herein can also be configured through a server-less computing environment, in which a cloud service provider can operate to provision, scale, or manage the infrastructure or components being utilized to execute computer readable instructions associated with the different aspects or embodiments herein, such as via network 2228, for example.

Although not required, aspects are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 22 illustrates an example of a system 2200 comprising a computing device 2212 configured to implement one or more aspects provided herein. In one configuration, computing device 2212 includes at least one processing unit 2216 and memory 2218. Depending on the exact configuration and type of computing device, memory 2218 may be volatile (such as RAM, for example), non-volatile (such as ROM, flash memory, etc., for example) or some combination of the two. This configuration is illustrated in FIG. 22 by dashed line 2214, which can comprise a system on a chip, processing circuitry, or other component(s) as described herein.

In other aspects, device 2212 may include additional features and/or functionality. For example, device 2212 may also include additional storage (e.g., removable or non-removable) including, but not limited to, magnetic storage, optical storage, and the like, as illustrated by storage 2220. In one aspect, computer readable instructions to implement one or more aspects provided herein by execution of the instructions can be stored in storage 2220. Storage 2220 may also store other computer readable instructions to implement an operating system, an application program, application modules in computing environments and the like. Computer readable instructions may be loaded in memory 2218 for execution by processing unit 2216, for example, including one or more processors for processing information or data in the workflow application or platform according to aspects described herein.

The term “computer readable media” as used herein includes computer storage media. Computer storage media includes volatile and nonvolatile, removable and non-removable media implemented in any method or technology for storage of information such as computer readable instructions or other data. Memory 2218 and storage 2220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 2212. Any such computer storage media may be part of device 2212.

Device 2212 may also include communication connection(s) 2226 that allows device 2212 to communicate with other devices, or interface along input and output terminals. Communication connection(s) 2226 may include, but is not limited to, a modem, a Network Interface Card (NIC), an integrated network interface, a radio frequency transmitter/receiver, an infrared port, a USB connection, or other interfaces for connecting computing device 2212 to other computing devices. Communication connection(s) 2226 may include a wired connection or a wireless connection. Communication connection(s) 2226 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 2218 and storage 2220 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 2212. Any such computer readable storage media may be part of device 2212.

Device 2212 may also include communication connection(s) 2226 that allows device 2212 to communicate with other devices, which are discussed herein. Communication connection(s) 2226 may include, but is not limited to, a modem, a Network Interface Card (NIC), an integrated network interface, a radio frequency transmitter/receiver, an infrared port, a USB connection, or other interfaces for connecting computing device 2212 to other computing devices. Communication connection(s) 2226 may include a wired connection or a wireless connection. Communication connection(s) 2226 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 2212 may include input terminals or input device(s) 2224 such as keyboard, mouse, pen, voice input device, touch input device, infrared cameras, video input devices, and/or any other input device, along with input terminals or connections for wired or wireless connections. Output device(s) 2222 such as one or more displays, speakers, printers, and/or any other output device may also be included in device 2212, along with output terminals or connections for wired or wireless connections. Input device(s) 2224 and output device(s) 2222 may be connected to device 2212 via a wired connection, wireless connection, or any combination thereof. In one aspect, an input device or an output device from another computing device may be used as input device(s) 2224 or output device(s) 2222 for computing device 2212.

Components of computing device 2212 may be connected by various interconnects, such as a bus. Such interconnects may include a Peripheral Component Interconnect (PCI), such as PCI Express, a Universal Serial Bus (USB), firewire (IEEE 2294), an optical bus structure, and the like. In another aspect, components of computing device 2212 may be interconnected by a network. For example, memory 2218 may be comprised of multiple physical memory units located in different physical locations interconnected by a network 2228 or via a cloud-based system of one or more servers.

Storage devices utilized to store computer readable instructions may be distributed across a cloud, or network 2228. For example, a computing device 2230 accessible via network 2228 may store computer readable instructions to implement one or more aspects provided herein. Computing device 2212 may access computing device 2230 and download a part or all of the computer readable instructions for execution. Alternatively, computing device 2212 may download pieces of the computer readable instructions, as needed, or some instructions may be executed at computing device 2212 and some at computing device 2230.

Various operations of aspects are provided herein. In one aspect, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each aspect or embodiment provided herein for sake of brevity of description, but not necessarily limited by any such aspect or example.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., applications, elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

A first example can be a system of an enterprise network, comprising: a memory that stores executable instructions; and a processor, communicatively coupled to the memory, that causes execution of the executable instructions to perform operations in an application, the operations comprising: generating a plurality of Quick Response (QR) codes or a plurality of radio frequency identification (RFID) tags corresponding to a plurality of locations for a plurality of user equipment devices (UEs), wherein a location of the plurality of locations corresponds to a QR code of the plurality of QR codes or an RFID tag of the plurality of RFID tags at the location; and providing sets of tasks associated with a plurality of status levels at the location to the plurality of UEs in response to an authentication with the QR code or the RFID tag within a proximity area of the location, wherein each of the sets of tasks are different with each of the plurality of status levels.

A second example can include the first example, wherein each QR code of the plurality of QR codes and each RFID tag of the plurality of RFID tags corresponds to a plurality of user profiles associated with different status levels with different assigned tasks for completion at the location, and wherein the plurality of QR codes and the plurality of RFID tags comprise different proximity areas of the plurality of locations, respectively.

A third example can include the first or second example, wherein the QR code, or the RFID tag, is associated with a plurality of user profiles and the plurality of status levels comprising a room preparation level with preparation tasks assigned to a first user profile, a housekeeping level with housekeeping tasks assigned to a second user profile, and an inspection level with inspection tasks assigned to a third user profile.

A fourth example can include any one or more of the first through third examples, the operations further comprising: assigning, or performing, via the third user profile, the plurality of status levels to any one or more of the plurality of status levels, and to the QR code or the RFID tag of the location, wherein the plurality of status levels comprise a hierarchical order; and activating any status level following a first status level of the plurality of status levels upon completion of a set of tasks of a preceding status level.

A fifth example can include any one or more of the first through fourth examples, wherein the sets of tasks are based on one or more of: a level of experience, a level of training, a status level of a user profile, or a station within the proximity area of the location associated with the QR code or the RFID tag.

A sixth example can include any one or more of the first through fifth examples, the operations further comprising: activating a set of tasks based on a status level and a user profile of a UE in response to the UE scanning the QR code or the RFID tag; providing the set of tasks to the UE; and providing a notification to another user profile in response to an activation or a completion of the set of tasks.

A seventh example can include any one or more of the first through sixth examples, the operations further comprising: providing a selection of the location from among the plurality of locations based on the QR code or the RFID tag; and providing a request for a guest profile to add to a task to a set of tasks.

An eighth example can be a computer-readable storage device configured to store computer executable instructions that, in response to execution by one or more processors, cause computer system to perform operations, the operations comprise: generating a Quick Response (QR) code or a radio frequency identification (RFID) tag corresponding to a location of an entity for a plurality of user equipment devices (UEs); triggering a request for authentication by a first UE of the plurality of UEs based on the QR code or the RFID tag within a proximity area of the QR code or the RFID; receiving the request for authentication by the first UE; authenticating the first UE based on a security protocol based on a first user ID; determining a status of the location of the entity; and providing a set of first tasks to the first UE based on the status of the location and the first user ID.

A ninth example can include the eighth example, the operations further comprise: in response to receiving one or more indications of a completion of the set of first tasks, modifying the status of the location of the entity from a first status level to a second status level associated with a set of second tasks that differ from the set of first tasks.

A tenth example can include any one or more of the eighth through ninth examples, the operations further comprise: authenticating a second UE based on the QR code or the RFID tag at the location; and providing a set of second tasks to the second UE based on a second status level or a level of completion of a set of first tasks associated with the first user ID and a second user ID of the second UE.

An eleventh example can include any one or more of the eighth through tenth examples, the operations further comprise: authenticating a third UE based on the QR code or the RFID tag at the location; and providing a set of third tasks to the third UE based on a third task level or a completion of the set of first tasks and a set of second tasks at the location that correspond to a first UE and a second UE, respectively, and based on a third user ID associated with the third UE.

A twelfth example can include any one or more of the eighth through eleventh examples, the operations further comprise: providing instructional information with the set of first tasks to the first UE based on an experience level associated with the first user ID.

A thirteenth example can include any one or more of the eighth through twelfth examples, the operations further comprise: in response to the set of first tasks being indicated as completed from the first UE, notifying a second UE to activate a set of second tasks by scanning the QR code or the RFID tag at the location and perform the set of second tasks based on one or more parameters comprising at least one of: a period of completion, instructional training information, location information, any reported issues, an inventory of supplies, or stations of the location; and tracking a progress of the set of first tasks and the set of second tasks at the location.

A fourteenth example can include any one or more of the eighth through thirteenth examples, the operations further comprising: authenticating a guest UE associated with the location of the entity based on the QR code or the RFID tag; receiving, via a wireless link, a request for a task to be completed at the location of the entity; modifying the set of first tasks or a set of second tasks associated with a second UE based on the request; and notifying the first UE or the second UE of a modified set of first tasks or a modified set of second tasks, respectively.

A fifteenth example can be a user equipment (UE) comprising: a memory; and processing circuitry configured, when executing instructions stored in the memory, to: detect a Quick Response (QR) code or a radio frequency identification (RFID) tag associated with a first proximity area of a location; perform a security protocol to authenticate the UE with the location in response to detecting the QR code or the RFID tag; and receive a status level of the location and a set of first tasks associated with the status level.

A sixteenth example can include the fifteenth example, wherein the status level indicates a progress status of the set of first tasks associated with a plurality of user profiles assigned to the QR code or the RFID tag at the location, the set of first tasks comprising at least one of: a plurality of preparation tasks, a plurality of housekeeping tasks, a plurality of inspection tasks or a guest request task.

A seventeenth example can include any one or more of the fifteenth through sixteenth examples, wherein the processing circuitry is further configured to: provide an indication of a completed task of the set of first tasks; advancing a progress status in the status level; and reporting the progress status associated with the QR code or the RFID tag at the location.

An eighteenth example can include any one or more of the fifteenth through seventeenth examples, wherein the processing circuitry is further configured to: select or assign the location from among a plurality of locations to the UE or another UE; and modify the set of first tasks associated with the QR code or the RFID tag at the location based on one or more of: a level of experience, a level of training, a status level of a user profile for the UE, a station within the first proximity area of the location, a period of time for completion or one or more sites comprising a plurality of locations.

A nineteenth example can include any one or more of the fifteenth through eighteenth examples, wherein the processing circuitry is further configured to: receive a notification of one or more other locations associated with one or more other QR codes or one or more other RFID tags assigned with sets of second tasks to be completed or already completed; and providing a notification to activate another status level in response to a completion indication of the set of first tasks.

A twentieth example can include any one or more of the fifteenth through nineteenth examples, wherein the processing circuitry is further configured to: generate a photo of a station at the location; and transmit the photo of the station in a report for additional assistance.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A system of an enterprise network, comprising:
a memory that stores executable instructions; and
a processor, communicatively coupled to the memory, that causes execution of the executable instructions to perform operations, the operations comprising:
generating a plurality of Quick Response (QR) codes or a plurality of radio frequency identification (RFID) tags corresponding to a plurality of locations for a plurality of user equipment devices (UEs), wherein a location of the plurality of locations corresponds to a QR code of the plurality of QR codes or an RFID tag of the plurality of RFID tags at the location; and
providing sets of tasks associated with a plurality of status levels at the location to the plurality of UEs in response to an authentication with the QR code or the RFID tag within a proximity area of the location, wherein each of the sets of tasks are different with each of the plurality of status levels.

2. The system of claim 1, wherein each QR code of the plurality of QR codes and each RFID tag of the plurality of RFID tags corresponds to a plurality of user profiles associated with different status levels with different assigned tasks for completion at the location, and wherein the plurality of QR codes and the plurality of RFID tags comprise different proximity areas of the plurality of locations, respectively.

3. The system of claim 1, wherein the QR code, or the RFID tag, is associated with a plurality of user profiles and the plurality of status levels comprising a room preparation level with preparation tasks assigned to a first user profile, a housekeeping level with housekeeping tasks assigned to a second user profile, and an inspection level with inspection tasks assigned to a third user profile.

4. The system of claim 3, the operations further comprising:
assigning, or performing, via the third user profile, the plurality of status levels to any one or more of the plurality of status levels, and to the QR code or the RFID tag of the location, wherein the plurality of status levels comprise a hierarchical order; and
activating any status level following a first status level of the plurality of status levels upon completion of a set of tasks of a preceding status level.

5. The system of claim 1, wherein the sets of tasks are based on one or more of: a level of experience, a level of training, a status level of a user profile, or a station within the proximity area of the location associated with the QR code or the RFID tag.

6. The system of claim 1, the operations further comprising:
activating a set of tasks based on a status level and a user profile of a UE in response to the UE scanning the QR code or the RFID tag;
providing the set of tasks to the UE; and
providing a notification to another user profile in response to an activation or a completion of the set of tasks.

7. The system of claim 1, the operations further comprising:
providing a selection of the location from among the plurality of locations based on the QR code or the RFID tag; and
providing a request for a guest profile to add to a task to a set of tasks.

8. A computer-readable storage device configured to store computer executable instructions that, in response to execution by one or more processors, cause computer system to perform operations, the operations comprise:
generating a Quick Response (QR) code or a radio frequency identification (RFID) tag corresponding to a location of an entity for a plurality of user equipment devices (UEs);
triggering a request for authentication by a first UE of the plurality of UEs based on the QR code or the RFID tag within a proximity area of the QR code or the RFID;
receiving the request for authentication by the first UE;
authenticating the first UE based on a security protocol based on a first user ID;
determining a status of the location of the entity; and
providing a set of first tasks to the first UE based on the status of the location and the first user ID.

9. The computer-readable storage device of claim 8, the operations further comprise:
in response to receiving one or more indications of a completion of the set of first tasks, modifying the status of the location of the entity from a first status level to a second status level associated with a set of second tasks that differ from the set of first tasks.

10. The computer-readable storage device of claim 8, the operations further comprise:
authenticating a second UE based on the QR code or the RFID tag at the location; and
providing a set of second tasks to the second UE based on a second status level or a level of completion of a set of first tasks associated with the first user ID and a second user ID of the second UE.

11. The computer-readable storage device of claim 8, the operations further comprise:
authenticating a third UE based on the QR code or the RFID tag at the location; and
providing a set of third tasks to the third UE based on a third task level or a completion of the set of first tasks and a set of second tasks at the location that correspond to a first UE and a second UE, respectively, and based on a third user ID associated with the third UE.

12. The computer-readable storage device of claim 8, the operations further comprise:
providing instructional information with the set of first tasks to the first UE based on an experience level associated with the first user ID.

13. The computer-readable storage device of claim 8, the operations further comprise:
in response to the set of first tasks being indicated as completed from the first UE, notifying a second UE to activate a set of second tasks by scanning the QR code or the RFID tag at the location and perform the set of second tasks based on one or more parameters comprising at least one of: a period of completion, instructional training information, location information, any reported issues, an inventory of supplies, or stations of the location; and
tracking a progress of the set of first tasks and the set of second tasks at the location.

14. The computer-readable storage device of claim 8, the operations further comprising:
authenticating a guest UE associated with the location of the entity based on the QR code or the RFID tag;
receiving, via a wireless link, a request for a task to be completed at the location of the entity;
modifying the set of first tasks or a set of second tasks associated with a second UE based on the request; and
notifying the first UE or the second UE of a modified set of first tasks or a modified set of second tasks, respectively.

15. A user equipment (UE) comprising:
a memory; and
processing circuitry configured, when executing instructions stored in the memory, to:
detect a Quick Response (QR) code or a radio frequency identification (RFID) tag associated with a first proximity area of a location;
perform a security protocol to authenticate the UE with the location in response to detecting the QR code or the RFID tag; and
receive a status level of the location and a set of first tasks associated with the status level.

16. The UE of claim 15, wherein the status level indicates a progress status of the set of first tasks associated with a plurality of user profiles assigned to the QR code or the RFID tag at the location, the set of first tasks comprising at least one of: a plurality of preparation tasks, a plurality of housekeeping tasks, a plurality of inspection tasks or a guest request task.

17. The UE of claim 15, wherein the processing circuitry is further configured to:
provide an indication of a completed task of the set of first tasks;
advancing a progress status in the status level; and
reporting the progress status associated with the QR code or the RFID tag at the location.

18. The UE of claim 15, wherein the processing circuitry is further configured to:
select or assign the location from among a plurality of locations to the UE or another UE; and
modify the set of first tasks associated with the QR code or the RFID tag at the location based on one or more of: a level of experience, a level of training, a status level of a user profile for the UE, a station within the first proximity area of the location, a period of time for completion or one or more sites comprising a plurality of locations.

19. The UE of claim 15, wherein the processing circuitry is further configured to:
receive a notification of one or more other locations associated with one or more other QR codes or one or more other RFID tags assigned with sets of second tasks to be completed or already completed; and
providing a notification to activate another status level in response to a completion indication of the set of first tasks.

20. The UE of claim 15, wherein the processing circuitry is further configured to:
generate a photo of a station at the location; and
transmit the photo of the station in a report for additional assistance.
